(19) United States
(12) Patent Application Publication
(10) Pub. No.: US 2026/0320889 A1
(43) Pub. Date: Oct. 15, 2026

(54) ROBOT AVATAR

(71) Applicant: Massachusetts Institute of Technology, Cambridge, MA (US)

(72) Inventor: Haruhiko Harry Asada, Lincoln, MA (US)

(73) Assignee: Massachusetts Institute of Technology, Cambridge, MA (US)

(21) Appl. No.: 19/100,973

(22) PCT Filed: Aug. 4, 2023
(86) PCT No.: PCT/US2023/029530

§ 371 Date: Feb. 4, 2025

Related U.S. Application Data
(60) Provisional application No. 63/370,532, filed on Aug. 5, 2022.

(51) Int. Cl. G06T 13/40; B25J 9/16; B25J 11/00; B25J 13/08; G06F 3/01

(52) U.S. Cl. CPC G06T 13/40; B25J 9/1669; B25J 9/1689; B25J 11/009; B25J 13/089; G06F 3/011

(57) ABSTRACT

Systems and related methods for assisting a user are disclosed. An end effector may be moved to assist the user in the world space. A visual representation of an avatar may be generated and superimposed on a corresponding location of the end effector in a virtual space. Poses, configurations, and movements of the avatar in the virtual space may be synchronized with the corresponding poses, configurations, and movement of the end effector in the world space. The virtual space may be displayed to a user, optionally using a wearable display configured to be worn by the user.

### RELATED APPLICATIONS

This application claims the benefit of priority under 35 U.S.C. § 119(e) to U.S. Provisional Application Ser. No. 63/370,532, filed Aug. 5, 2022, the disclosure of which is incorporated herein by reference in its entirety.

### FIELD

Disclosed embodiments are related to robot avatars.

### BACKGROUND

Users can interact with one another in a variety of virtual environments including the metaverse. However, such interactions in the virtual environments are limited in that there are no physical interactions among the users. Devices such as head mounted displays that provide visual and audio feedback to the user can provide the user a sense of immersion in the virtual environment. Although audio and visual stimuli are dominating factors, humans use other senses in real environments. Haptic rendering can augment the sense of immersion for a user by adding physical touch to the experience of the user, however, existing haptic devices are cumbersome to operate and are limited to specific applications.

Augmented reality can provide a user with useful information about the environment and a task to perform. A primary function of augmented reality is to provide information; however the augmented reality does not enable a user to perform a physical task.

Tele-robotics allows a user to operate a robot from a distance. To assist a human operator in controlling a remote robot, various means exist for transmitting the state and situation observed at the remote site back to the human operator. The means include audio and visual information as well as haptic information obtained from physical interactions between the robot and its environment.

The concept of tele-presence was originated in tele-robotics, where an operator console was separated from the remote robot and extended to a virtual environment.

### SUMMARY

In some embodiments, a system for assisting a user comprises a moveable end effector in a world space and a display configured to display a virtual space to the user. The system for assisting a user further comprises at least one processor configured to obtain a pose of the end effector in the world space, generate a visual representation of an avatar based at least in part on the pose of the end effector, and superimpose the visual representation of the avatar with a location of the end effector in the virtual space.

In some embodiments, a method for assisting a user comprises obtaining a pose of an end effector in a world space, generating a visual representation of an avatar based at least in part on the pose of the end effector, and superimposing the visual representation of the avatar with a location of the end effector in the virtual space.

One aspect of the disclosure herein is a system comprising a display worn by a human and a robot that interacts with the human, where said display projects a virtual human image in space so that the human feels that the projected virtual human interacts with the human instead of the robot.

In one embodiment of the system disclosed herein, the virtual human moves and is animated in coordination with the robot so that the end-effector and other parts of said robot body that physically interact with the human may be collocated and synchronized with corresponding parts of said projected virtual human.

In one embodiment of the system disclosed herein, the robot is remotely operated by a remote operator, so that the remote operator interacts with the human through an avatar, wherein the avatar is a combination of the virtual human and the robot.

In one embodiment, a computer system for controlling a robot, comprises: a processing system; computer storage accessible to the processing system, and computer program instructions encoded on the computer storage, where when the computer program instructions are processed by the processing system, the computer system is configured to: define data structures in the computer storage representing the robot; and execute a program module applied to the data structures to project an image for a human in contact with the robot.

One aspect of the disclosure herein is a computer program product comprising computer storage and computer program instructions encoded on the computer storage, wherein the computer program instructions, when processed by a processing system of a computer, causes the computer to implement the computer system disclosed herein.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a system for assisting a user according to some embodiments;

FIG. 2 shows a system for assisting a user including a visual representation of an avatar according to some embodiments;

FIG. 3 shows a system for assisting a user including a visual representation of an avatar and an operator according to some embodiments;

FIG. 4 shows a schematic diagram of a method of assisting a user according to some embodiments;

FIG. 5 shows a block diagram of a general-purpose computer which processes computer programs using a processing system according to some embodiments; and

FIG. 6 shows a schematic embodiment of a system for use in implementing systems and methods disclosed herein according to some embodiments.

### DETAILED DESCRIPTION

Embodiments disclosed may herein relates to human-machine systems. In such an application, a robot may physically interact with a human as the avatar of another human at a different location. A robot may interact with a human using a physical end-effector. However, users may not be comfortable interacting with a robot, which may be operated remotely in some situations, for a variety of reasons. Therefore, there may be resistance from a user in accepting assistance, treatment, or otherwise interacting with a robot in such situations.

In view of the above, the Inventor has recognized that it may be beneficial to display an avatar to a user in a location within a virtual space that may be synchronized with the pose and movement of one or more portions of the robot in the world space (e.g., an end effector interacting with the user). Thus, it may appear to the user as if the avatar in the virtual space is interacting with the user rather than the robot. In one potential embodiment, a human may wear a head-mounted display, or another display may be used in other embodiments. A visual representation (e.g., 3-dimensional image) of another human may be created and projected into a virtual space displayed to the user, such that the human interacting with the robot sees the image of the other person or another virtual avatar displayed in the virtual space. Namely, the projected image may act as the avatar of the other human. The human interacting with the robot may sometimes be referred to as Human-A or as a user, while the human represented by the avatar may sometimes be referred to as Human-B or as an operator. The robot may be controlled remotely by Human-B from a remote site, while Human-A feels as if he/she physically interacts with Human-B instead of the robot. This allows Human-B to physically interact with Human-A through his/her robot avatar, while Human-A gets immersed in the hybrid virtual/physical environment augmented with haptic sensation and physical effects. However, embodiments in which the robot is controlled autonomously without the input of a separate operator are also contemplated. The wearable device may be a head mounted display, augmented reality glasses, or other 2D or 3D displays projecting an image overlapping with a pose of the robot within the virtual space displayed to a user.

An example of where this invention may be used is tele-nursing. Consider an older adult or a patient who needs physical assistance from a remote caregiver. A remotely operated robot, or any other assistive device controlled remotely, is to physically interact with the older adult, that is Human-A. Physical interactions are required for guiding and supporting Human-A in walking, transferring Human-A from a bed to chair, and performing other tasks. Exposing a mechanistic robot may scare or make uncomfortable Human-A, particularly when the machine is operated remotely, and no human caregiver is attending the assistive operation. This invention may solve this type of problem. Human-A may wear a device for projecting the image of the remote caregiver, i.e., Human-B, so that the older adult feels as if the caregiver is sitting next to him/her and providing physical assistance. The actual physical assistance is provided by the robot, but the older adult would see it as a real caregiver.

In some preferred embodiments, the movement of the robot may preferably be synchronized and matched with the video image of the avatar. For example, the movement of a robotic arm, or other actuatable robot, having an end effector in a world space in which the user is located may be synchronized with the movement of the visual representation of the avatar within the virtual space. Both temporal and spatial coordination may be established to achieve the synchronization. With proper coordination, the audio-visual sensation and haptic sensation may work synergistically. Compared to systems limited to audio-visual devices, synchronized audio-visual-haptic stimuli may provide the wearer with a stronger feeling of reality and immersion. In the context of tele-nursing, the older adult may that the avatar feels more humanistic and easier to interact with, which may contribute to building a trustful relationship (e.g., between the user and operator).

In addition to the above, the Inventor has recognized difficulties associated with syncing up visual representations in a virtual space with the movements of an end effector that operates in a world space surrounding a user. These difficulties include complexities associated with aligning the timing of movement of the robotic arm in the world space and the visual representation of the avatar in the virtual space with one another. This issue may be exacerbated by any delays in the time to transfer information (e.g., images of physical positioning of bodies) from the user to the operator and vice versa. Such delays may be caused by poor internet connectivity, hardware issues, and any other appropriate source of delays. Accordingly, the Inventors have recognized a need for methods of synchronizing the motion and location of an avatar in a virtual space with movements of the end effector and/or other portions of an actuatable system in the world space.

Following from the above, determining the pose, configuration, and/or movement of the robot in the world space may include determining the pose, configuration, and/or movement of the end effector in a world space. Obtaining the pose of the end effector may include one or both of imaging the end effector and sensing the pose of the end effector using sensors. For example, the end effector may be imaged, and the pose of the end effector may be determined based at least in part on the images. Alternatively or additionally, one or more sensors may be configured to sense joint configurations of the end effector and any robotic arm coupled thereto and may be used to determine the pose of the end effector in addition to or in place of the images. For example, encoders, displacement sensors, or other appropriate sensors may be used to determine the configuration of the different portions of the robotic system such that the pose of the end effector may be determined based on the sensed configuration of the different joints.

Synchronizing the pose, configuration, and/or movement of the end effector in the world space with the avatar in the virtual space may include transforming a reference frame of the world space to a reference frame of the virtual space. Transforming the reference frame may include translating and/or scaling the reference frame. The world space may be linearly or non-linearly scaled to the virtual space according to some embodiments. Interactions with real world environments may also include an additional non-linear transformation of the joint movement of the system to account for the interaction point of the system with the environment. In some embodiments, a Jacobian matrix may be used to transform the world reference frame to the virtual reference frame. Of course, other appropriate methods for transforming between the world and virtual spaces may be used. In either case, a pose of an end effector, or other portion of a robot, within the world space may be transformed to a corresponding pose within the virtual space to be displayed to a user. Thus, the use of a transformation between the world space and the virtual space may help to synchronize the pose, configuration, and the movement of the end effector and/or robotic arm in the world space to the virtual representation of the avatar in the virtual space.

With information associated with the end effector obtained, the visual representation of the avatar may be generated in the virtual space. For example, a three-dimensional model of an avatar may be generated in the virtual space. However, use of a two-dimensional model of the avatar in a two dimensional virtual space is also contemplated. The visual representation may be generated using one or more algorithms and/or models according to some embodiments. For example, the obtained pose of the end effector may be provided to one or more algorithms and/or models, and the one or more algorithms and/or models may output (e.g., generate) the visual representation of the avatar in the virtual space. The visual representation of the avatar may be human or humanoid according to some embodiments. However, the avatar may correspond to any desired type of avatar for interaction with a user within the virtual space as the avatar is not limited to a human. In either case, the generated visual representation may be updated (e.g., generated again) any number of times with any desired frequency, and may be updated based on movement of the end effector in the world space such that movement of the avatar within the virtual space may be synchronized with movement of the end effector, or other portion of a robot, within the world space.

The virtual space including the generated visual representation of the avatar may be superimposed on a location of the end effector and/or any other desired portion of a robot in the virtual space corresponding to the location of the end effector, or other portion of the robot, within the world space. The avatar may be superimposed such that when the virtual space including the superimposed avatar is displayed to the user, the pose, configuration, and movement of the avatar appears synchronized with the pose, configuration, and movement of the end effector and/or robotic arm. For example, a generated hand of the avatar in the virtual space may track the pose, configuration, and movement of the end effector in the world space. As such, if the hand in the virtual space is displayed to the user, it may appear to the user that the hand in the virtual space is interacting with the real world environment (e.g., world space). For example, the end effector may grasp an arm of the user in the world space to assist the user, and the virtual representation of the avatar being displayed to the user in the virtual space may appear to be grasping the arm of the user.

Displaying the virtual space including the virtual representation of the avatar to the user may involve generating a visual of the avatar in the virtual space as noted above and displaying the virtual space to the user. In some embodiments, only the avatar from the virtual space may be displayed to the user. Displaying only the avatar to the user may enhance immersion of the user in the virtual world according to some embodiments. Alternatively, virtual representations of elements which may or may not exist in the world space environment may be generated and displayed to the user. For example, furniture, floors, ceilings, tools, and any other appropriate elements of the environment or objects may be displayed to the user. In some embodiments, the elements of the environment or objects displayed to the user may enhance the immersion of the user. Any appropriate display or method of displaying the world space to the user within the virtual space may be implemented with the systems and methods described herein.

A display configured to display the virtual space to the user may be configured to be worn by the user according to some embodiments. For example, glasses, goggles, headsets, or other structure capable of being worn on the head of a user may be configured to display the virtual space and the visual representation of the avatar to the user. In some embodiments, monitors, projectors, mobile devices including display screens (e.g., smart phones and tablets, any combination thereof, and any other appropriate display may be used herein as the disclosure is not limited to any particular display. Further, the one or more displays may be integrated with the above noted wearable structure such that the one or more displays may display the space to the user when the wearable structure is worn.

For the sake of clarity, in the various embodiments disclosed herein, an end effector is interacting with a user is described as being positioned on a robotic arm. However, the end effector may be integrated with any controllable robotic system as the disclosure is not so limited. Thus, in some embodiments, the end effector may be coupled to one or more actuators including but not limited to a solenoid, pneumatic actuator, hydraulic actuator, and/or motor as well as one or more translatable and/or rotatable joints, connections, or other moveable structures such that the pose of the end effector may be controlled. Thus, the one or more actuators may be configured to move the end effector between desired poses in the world space. Thus, one or more actuators may be used in place of or in addition to the robotic arm described in any one of the embodiments disclosed herein as the disclosure is not so limited.

As used herein, the term “end effector” may refer to a component of a system configured to interact with the surrounding environment. For example, the end effector of a robotic arm may be a gripper that is configured to interact with the surrounding environment and/or a user by grasping, pushing, pulling, or performing any other appropriate action to the surrounding environment. Other appropriate types of end effectors may include surgical tools, applicators, brushes, and/or markers disposed on a distal end portion of a robotic arm, and/or any other appropriate type of end effector configured to interact with an environment surrounding a system as the disclosure is not so limited.

As used herein, the “configuration” of a robotic arm may refer to relative positioning and orientation of the associated components in the robotic arm. For example, for an arm including a plurality of linkages a configuration may be defined in terms of the angles and/or distances between the different linkages. Regardless of the specific parameters associated with a given robotic arm, the configuration may describe a position and/or orientation in space of the robotic arm. Depending on the context, a configuration may be described in a world space or virtual space. For example, a configuration of an end effector may include a position and/or orientation of the end effector in a world space while the position and/or orientation of the virtual representation of the avatar may also be defined as a configuration of the avatar in the virtual space.

Different reference frames are discussed throughout the current disclosure including a world space and a virtual space. A world space may describe a reference frame of the real world and/or surrounding environment in which a system is located and may interact with. For example, movement of an end effector in the world space may correspond to the observed physical movement of the end effector within the surrounding environment. A virtual space may refer to a reference frame of a virtual environment that may be generated using a computer processor. In some embodiments, the world space may be mapped onto the virtual space using an appropriate transformation such a pose of one or more objects in the world space (e.g., the end effector) may be mapped onto a corresponding location and with a corresponding orientation in the virtual space such that the pose of the end effector is consistent in both the virtual and world spaces. The virtual space may be selectively displayed to a user and the user may be able to see the virtual space. Sometimes, the virtual space may be referred to as “augmented reality” and accordingly the virtual space may sometimes be referred to as an “augmented reality space”. In some embodiments, the world space may be linearly mapped to the virtual space such that a movement in the world space results in a corresponding scaled (up or down) movement of the end effector in the virtual space. This may include commanded positions, angles, extension distances, or other appropriate parameters that may be used to characterize a configuration of a controllable portion of a system. It should be understood that other types of spaces are contemplated as the disclosure is not limited to any specific space including an end effector.

As used herein, a pose may refer to a position and orientation of a component within a specific reference frame. For example, a pose of an end effector may refer to both the position and orientation of the end effector within a particular reference frame. In terms of a world space reference frame, the pose of the end effector may refer to the position and orientation of the end effector in the surrounding environment. However, it should be understood for purposes of the various embodiments disclosed herein that controlling a pose of a particular component may also include controlling a position or orientation of the component as the disclosure is not limited in this fashion.

Determining the pose of an end effector (e.g., position and orientation of the end effector) may include using forward or inverse kinematics. Forward kinematics may use kinematic equations to determine the pose of an end effector using known values for joint parameters (e.g., sensed angles). Inverse kinematics may use kinematic equations to determine the joint parameters needed to achieve a corresponding end effector pose. Alternatively, a pose of the end effector may be determined using one or more sensors, such as one or more photosensitive detectors (e.g., two dimensional and/or three dimensional cameras) and corresponding pose tracking algorithms which may be used to identify the end effector within the image and determine a pose of the end effector within the three dimensional space observed by the one or more photosensitive detectors in the world space reference frame.

Specific non-limiting embodiments are described in further detail in regards to the figures. It should be understood that the various systems, components, features, and methods described relative to these embodiments may be used either individually and/or in any desired combination as the disclosure is not limited to only the specific embodiments described herein.

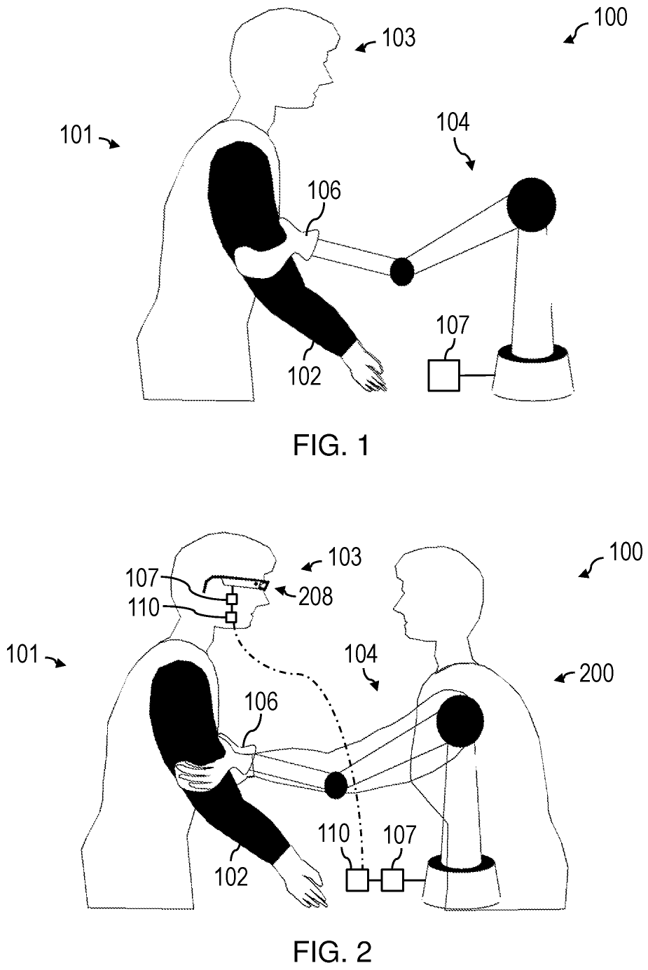

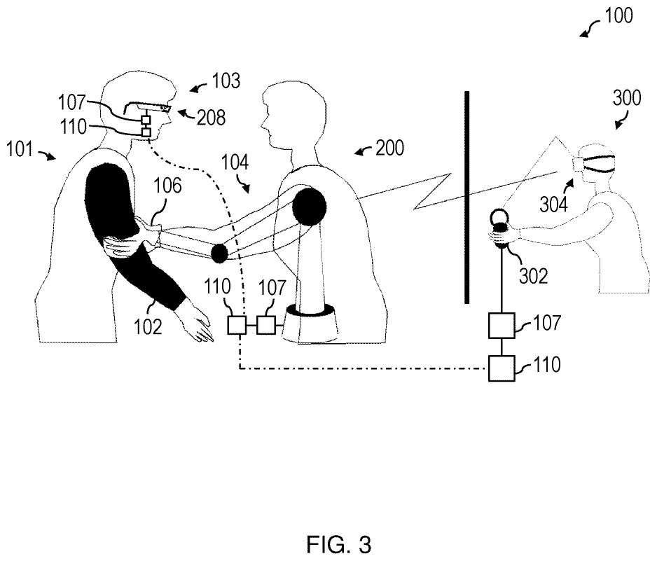

As shown in FIG. 1, a robot 104 may be configured to interact with a human 101 (e.g., user) with a physical end effector 106. The robot 104 optionally may interact with an arm of the human 101 as shown in FIGS. 1-3, although the robot 104 may interact with any appropriate portion of a body of the user 101. The human 101 may wear a display 208 (e.g., wearable head-mounted display device), as shown in FIG. 2. In embodiments where the display 208 is a wearable device, the display 208 may be positioned on a head 103 of the user 101, such as in the depicted embodiments of FIGS. 2-3. A 3-dimensional image of another human 200 (e.g., visual representation of an avatar) may be created and projected such that the human 101 sees the image of the other person 200. Namely, the projected image 200 acts as the avatar of the other human. The human 101 interacting with the robot 104 may be called Human-A, and the human represented by the avatar may be called Human-B. As shown in FIG. 3, the robot 104 may be controlled remotely by Human-B 300 from a remote site, and Human-A 101 may feel as if he/she physically interacts with Human-B 300 instead of the robot 104. This allows Human-B 300 to physically interact with Human-A 101 through his/her robot avatar 200, while Human-A 101 gets immersed in the hybrid virtual/physical environment augmented with haptic sensation and physical effects. The wearable device 208 may be a head mounted display, augmented reality glasses, or other 2D or 3D displays projecting an image of the virtual space that is overlapping with the robot 104 in the world space.

As shown in FIG. 3, a remote operator 300 may control one or both of the robotic arm 104 and end effector 106 using a control interface 302. The control interface 302 may be any appropriate type of control interface, including but not limited to one or more joysticks, buttons, switches, knobs, keyboards, computer mice, any other appropriate control interfaces the disclosure is not limited in this fashion. Optionally, the operator 300 may use a control display 304 to control the system. In some embodiments the control display 304 may be worn on the head of the operator 300. For example, the control display 304 may be formed as glasses or goggles that may be worn by the operator 300. The control display 304 may also be formed as any other appropriate display, including any of the displays recited herein. The control display 304 may display images or other virtual representations of one or more of the user 101, end effector 106, robotic arm 104, and the environment of the user 101 to the operator 300. The operator 300 may be in a remote location relative to the user 101 and end effector 106. In some embodiments, the avatar 200 may correspond to the physical appearance of the body of the operator 300, although the disclosure is not limited in this respect whatsoever, as the avatar 200 need not resemble the physical appearance of the operator 300. The end effector 106 and/or the robotic arm 104 may also be controlled automatically as the disclosure is not limited to an operator controlling the end effector 106 and/or the robotic arm 104.

One or more processors 107 and one or more transmitters 110 may be operatively coupled to the robotic arm 104, end effector 106, display 208, control interface 302, and/or control display 304. The one or more processors may be configured to control at least a portion of one or more of the robotic arm 104, end effector 106, display 208, control interface 302, and/or control display 304. The one or more transmitters 110 may be configured to enable communication among the one or more processors 107 as described herein. In some embodiments, one or both of the processors and the transmitter may be integrated with one or more of the robotic arm 104, end effector 106, display 208, control interface 302, and control display 304. The processors 107 and transmitters 110 may communicate via any appropriate communication protocol such as Wi-Fi, cellular, Bluetooth, or any other appropriate wireless communication protocol as the disclosure is not limited by any means of communication.

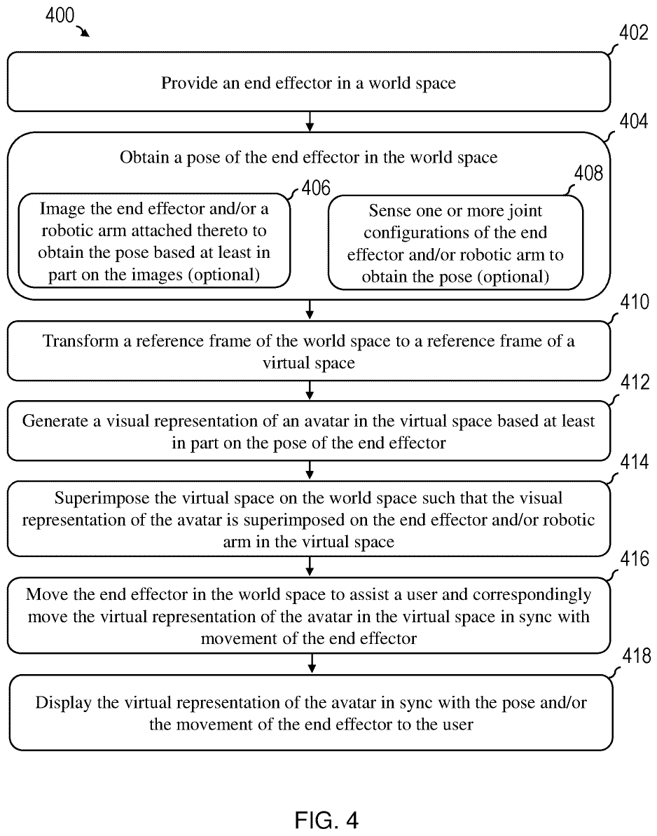

A method 400 of assisting a user such as Human-A 101 will be described with respect to FIG. 4 with reference to the example embodiments depicted in FIGS. 1-3. An end effector may be provided in a world space at 402. For example, an end effector 106, optionally coupled to a robotic arm 104 may be provided in a world space. A pose of the end effector may be obtained at 404. Obtaining the pose of the end effector at 404 may optionally include imaging the end effector and/or a robotic arm attached thereto to obtain the pose based at least in part on the images, see 406. For example, one or more photosensitive detectors may be configured to image the end effector 106 and/or the robotic arm 104. Obtaining the pose of the end effector at 404 may also optionally include sensing one or more joint configurations of the end effector and/or robotic arm to obtain the pose, see 408. For example, one or more joints (e.g., rotational and/or translational joints) associated with the end effector 106 and/or the robotic arm 104 may include sensors such as encoders, displacements sensors, or any other appropriate sensors configured to sense configurations of the one or more joints.

At 410, a reference frame of the world space may be transformed to a reference frame of a virtual space. For example, the world space may be linearly or non-linearly mapped to the virtual space. As such, distances, angles, velocities, and any other appropriate measurements in the world space may be determined in the virtual space from corresponding measurements and/or parameters determined in the world space. For example, a direction and velocity of movement of an end effector within the world space based either on a commanded and/or sensed motion of the end effector may also be transformed into a corresponding direction and velocity of movement of the end effector within the virtual space. At 412, a visual representation of an avatar in the virtual space may be generated based at least in part on the pose of the end effector. For example, the avatar 200 may be generated based on the pose of the end effector 106, and optionally based on the configuration of the robotic arm 104. The virtual space may be superimposed on the world space such that the visual representation of the avatar is superimposed on the end effector and/or robotic arm in the virtual space. For example, the avatar 200 may be at least partially superimposed on the transformed location of the end effector 106 and/or the robotic arm 104 in the virtual space.

The end effector may be moved in the world space to assist a user and the virtual representation of the avatar may be correspondingly moved in the virtual space in synchronization with movement of the end effector, see 416. For example, the end effector 106 may be moved in the world space to assist the user 101 and the virtual representation of the avatar 200 may be correspondingly moved in the virtual space in synchronization with movement of the end effector 106 and/or robotic arm 104. The virtual representation of the avatar may be displayed in sync with the pose and/or the movement of the end effector to the user, see 418. For example, the avatar 200 may be displayed in sync with the pose and/or the movement of the end effector 106 to the user 101. In some embodiments, this may correspond to simply performing steps 404 through 414 with a desired frequency such that the changing pose of the end effector may be obtained at a plurality of discrete time points and used to generate a sequence of different visual representations of the avatar to be superimposed on the location of the end effector in the virtual space. Thus, the sequence of images generated and displayed at these different time points may be synchronized with the movement of the end effector during movement of the end effector.

One or more computers can be used to implement a computational pipeline associated with the aforementioned systems and methods, using one or more general-purpose computers, such as devices including mobile devices, one or more server computers, or one or more database computers, or combinations of any two or more of these, which can be programmed to implement the functionality such as described in the example implementations.

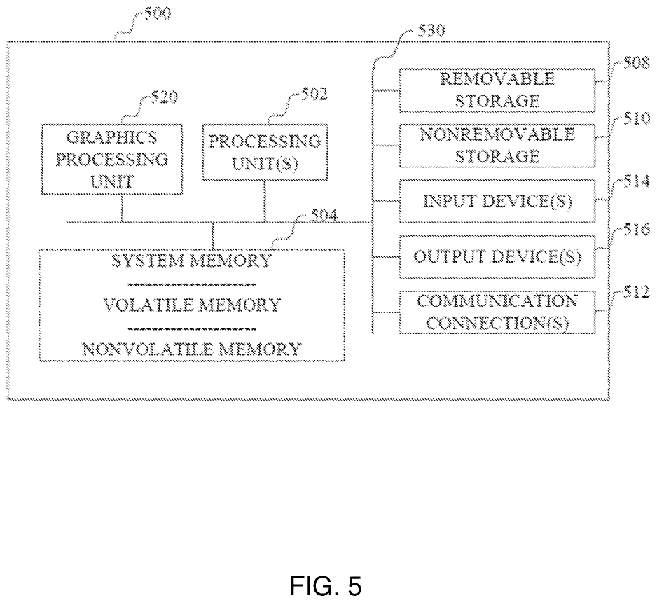

FIG. 5 shows a block diagram of a general-purpose computer which may process computer programs using a processing system. The computer programs on a general-purpose computer may include an operating system and applications. The operating system may be a computer program running on the computer that manages access to resources of the computer by the applications and the operating system. The resources may include memory, storage, communication interfaces, input devices and output devices.

Examples of such general-purpose computers may include, but are not limited to, larger computer systems such as server computers, database computers, desktop computers, laptop and notebook computers, as well as mobile or handheld computing devices, such as a tablet computer, handheld computer, smart phone, media player, personal data assistant, audio and/or video recorder, or wearable computing device.

With reference to FIG. 5, an example computer 500 may comprise a processing system including at least one processing unit 502 and a memory 504. The computer may have multiple processing units 502 and multiple devices implementing the memory 504. A processing unit 502 may include one or more processing cores (not shown) that operate independently of each other. Additional co-processing units, such as graphics processing unit 520, may also be present in the computer. The memory 504 may include volatile devices (such as dynamic random-access memory (DRAM) or other random-access memory device), and non-volatile devices (such as a read-only memory, flash memory, and the like) or some combination of the two, and optionally including any memory available in a processing device. Other memory such as dedicated memory or registers may also reside in a processing unit. Such a memory configuration is delineated by the dashed line 504 in FIG. 5. The computer 500 may include additional storage (removable and/or non-removable) including, but not limited to, solid state devices, or magnetically recorded or optically recorded disks or tape. Such additional storage is illustrated in FIG. 5 by removable storage 508 and non-removable storage 510. The various components in FIG. 5 are generally interconnected by an interconnection mechanism, such as one or more buses 530.

A computer storage medium is any medium in which data can be stored in and retrieved from addressable physical storage locations by the computer. Computer storage media includes volatile and nonvolatile memory devices, and removable and non-removable storage devices. Memory 504, removable storage 508 and non-removable storage 510 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

The computer 500 may also include communications connection(s) 512 that allow the computer to communicate with other devices over a communication medium. Communication media typically transmit computer program code, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 512 are devices, such as a network interface or radio transmitter, that interface with the communication media to transmit data over and receive data from signals propagated through communication media.

The communications connections may include one or more radio transmitters for telephonic communications over cellular telephone networks, and/or a wireless communication interface for wireless connection to a computer network. For example, a cellular connection, a Wi-Fi connection, a Bluetooth connection, and other connections may be present in the computer. Such connections support communication with other devices, such as to support voice or data communications.

The computer 500 may have various input device(s) 514 such as various pointer (whether single pointer or multi-pointer) devices, such as a mouse, tablet and pen, touchpad and other touch-based input devices, stylus, image input devices, such as still and motion cameras, audio input devices, such as a microphone. The computer may have various output device(s) 516 such as a display, speakers, printers, and so on, also may be included. These devices are well known in the art and need not be discussed at length here.

The various storage 510, communication connections 512, output devices 516 and input devices 514 may be integrated within a housing of the computer or may be connected through various input/output interface devices on the computer, in which case the reference numbers 510, 512, 514 and 516 may indicate either the interface for connection to a device or the device itself as the case may be.

An operating system of the computer may include computer programs, commonly called drivers, which manage access to the various storage 510, communication connections 512, output devices 516 and input devices 514. Such access generally includes managing inputs from and outputs to these devices. In the case of communication connections, the operating system also may include one or more computer programs for implementing communication protocols used to communicate information between computers and devices through the communication connections 512.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

Each component (which also may be called a “module” or “engine” or “computational model” or the like), of a computer system such as described herein, and which operates on one or more computers, may be implemented as computer program code processed by the processing system(s) of one or more computers. Computer program code includes computer-executable instructions and/or computer-interpreted instructions, such as program modules, which instructions are processed by a processing system of a computer. Generally, such instructions define routines, programs, objects, components, data structures, and so on, that, when processed by a processing system, instruct the processing system to perform operations on data or configure the processor or computer to implement various components or data structures in computer storage. A data structure may be defined in a computer program and specify how data is organized in computer storage, such as in a memory device or a storage device, so that the data may be accessed, manipulated, and stored by a processing system of a computer.

The various methods disclosed above may be implemented by one or more controllers including at least one processor operatively coupled to the various controllable portions of a system for assisting a user as disclosed herein. Alternatively or additionally, in some embodiments, the disclosed methods may be performed at least in part, and in some instances completely, on a computing device that is separate and removed from the disclosed systems for assisting a user. In either case, the disclosed methods may be embodied as computer readable instructions stored on non-transitory computer readable memory associated with the at least one processor such that when executed by the at least one processor the associated system, which may be a system for assisting a user in some embodiments, may perform any of the actions related to the methods disclosed herein. Additionally, it should be understood that the disclosed order of the steps is exemplary and that the disclosed steps may be performed in a different order, simultaneously, and/or may include one or more additional intermediate steps not shown as the disclosure is not so limited.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

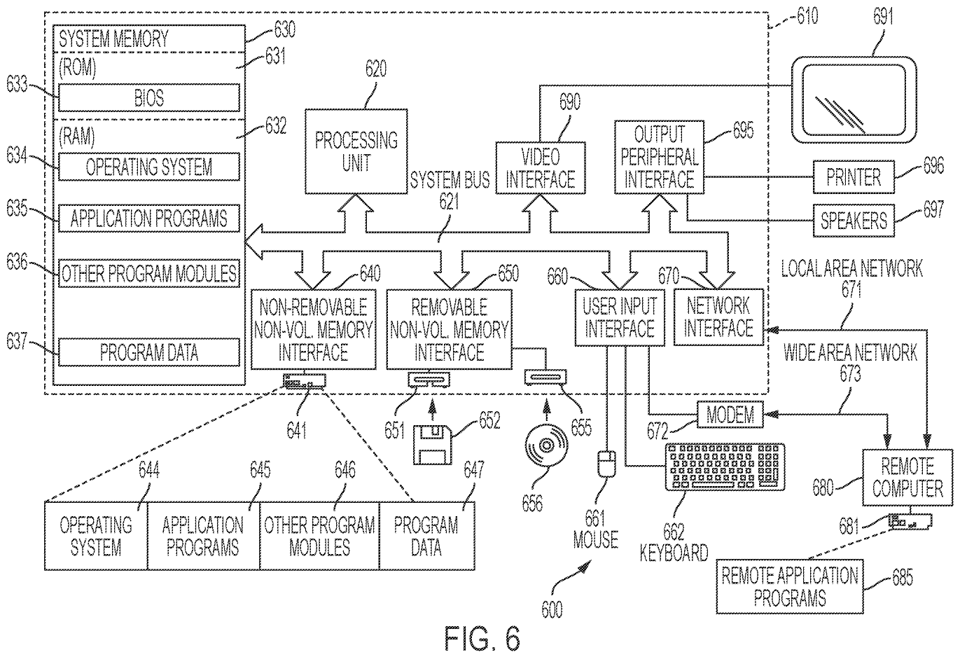

With reference to FIG. 6, an exemplary system for implementing aspects of the disclosure includes a general purpose computing device in the form of a computer 610 or other appropriate computing device. For example, the depicted computing device may be used as a processor configured to implement any of the methods disclosed herein. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673 but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

The various methods or processes outlined herein may be implemented in any suitable hardware. Additionally, the various methods or processes outlined herein may be implemented in a combination of hardware and of software executable on one or more processors that employ any one of a variety of operating systems or platforms. Examples of such approaches are described above. However, any suitable combination of hardware and software may be employed to realize any of the embodiments discussed herein.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A system for assisting a user, the system comprising:
a moveable end effector in a world space;
a display configured to display a virtual space to the user; and
at least one processor configured to:
obtain a pose of the end effector in the world space;
generate a visual representation of an avatar based at least in part on the pose of the end effector;
superimpose the visual representation of the avatar with a location of the end effector in the virtual space.

2. The system of claim 1, wherein the avatar includes at least a portion of a human avatar.

3. The system of claim 1, further comprising one or more sensors configured to sense the pose of the end effector in the world space.

4. The system of claim 1, wherein the pose is a commanded pose.

5. The system of claim 1, wherein the at least one processor is further configured to transform a reference frame of the world space to a reference frame of the virtual space to identify a location of the end effector in the virtual space.

6. The system of claim 1, further comprising a robotic arm configured to move the end effector.

7. The system of claim 6, further comprising one or more sensors configured to sense joint configurations of the robotic arm.

8. The system of claim 1, wherein the display is configured to be worn by the user.

9. The system of claim 1, wherein the end effector is configured to interact with a body of the user.

10. The system of claim 9, wherein the end effector is configured to manipulate and/or grasp a portion of the body of the user.

11. A method for assisting a user, the method comprising:
obtaining a pose of an end effector in a world space;
generating a visual representation of an avatar based at least in part on the pose of the end effector; and
superimposing the visual representation of the avatar with a location of the end effector in the virtual space.

12. The method of claim 11, wherein the avatar includes at least a portion of a human avatar.

13. The method of claim 11, further comprising transforming a reference frame of the world space to a reference frame of the virtual space to identify a location of the end effector in the virtual space.

14. The method of claim 11, wherein the pose is a commanded pose.

15. The method of claim 11, wherein obtaining the pose of the end effector includes sensing the pose of the end effector.

16. The method of claim 11, further comprising moving a robotic arm to move the end effector.

17. The method of claim 16, further comprising sensing joint configurations of the robotic arm.

18. The method of claim 11, further comprising interacting with a body of the user using the end effector.

19. The method of claim 18, further comprising manipulating and/or grasping a portion of the body of the user using the end effector.

20. A non-transitory computer readable memory including processor executable instructions that when executed by at least one processor perform the method of claim 11.
